(19) United States
(12) Patent Application Publication
(10) Pub. No.: US 2006/0194167 A1
(43) Pub. Date: Aug. 31, 2006

(54) Device for intraoral suctioning

(76) Inventor: Adolf Friedrich Rinne, Rinteln (DE)

Correspondence Address: SHLESINGER, ARKWRIGHT & GARVEY LLP, Suite 600, 1420 King Street, Alexandria, VA, 22314, US

(21) Appl. No.: 11/355,235

(22) Filed: Feb. 16, 2006

Related U.S. Application Data
(63) Continuation of application No. PCT/EP04/07817, filed on Jul. 15, 2004.

(30) Foreign Application Priority Data
Aug. 16, 2003 (DE) 103 37 648.8

(51) Int. Cl. A61C 17/14

(52) U.S. Cl. 433/91

(57) ABSTRACT

Device for intraoral suctioning including a mouth suctioning tube releasably connected to a suctioning tube that is in turn releasably connected to a suctioning unit, and a pivotable, rotatable, and bendable swan-neck hollow tube is fixable to a dental treatment unit with a holding device. The suctioning tube is guidable through the hollow tube. The suctioning unit is releasably connected to the suctioning tube on the side of the holding device, the mouth suctioning tube being releasably connected on the free end of the suctioning tube.

### CROSS-REFERENCE TO RELATED APPLICATIONS

This application is a continuation of application no. Pct/EP2004/007817, filed Jul. 15, 2004, which claims the priority of German application no. 103 37 648.8, filed Aug. 16, 2003, and each of which is incorporated herein by reference.

### FIELD OF THE INVENTION

The invention concerns a device for intraoral suctioning, whereby an oral suctioning tube is releasably connected to a suctioning hose that is releasably connected to a suctioning unit.

### BACKGROUND OF THE INVENTION

Prior art dental suctioning technology is characterized by the manual guidance of the suctioning tube into the patient's mouth. Intraoral suctioning, both with and without an assistant, is an established procedure in dental practice. Treatment without an assistant, which is appealing from an economic standpoint, offers limited protection to the soft tissue from rotating dental instruments, and complete suctioning is not ensured. In addition, certain areas of surgery can be very difficult for the dentist, for anatomical reasons.

Furthermore, there are no known measures and means in the dental market and trade press for suppressing the broadband, generally characteristic white noise, at the site of origin that occurs during suctioning, which can fatigue and damage the cilia of human auditory cells. Instead, passive or active hearing protection, as offered as special equipment by hearing aid designers for example, is recommended.

Another problem is the known bite wedges used when the patient's mouth must remain open for a long time. Bite wedges made of hard rubber are used to keep the patient's mouth open for extended periods to counteract tiredness and the reflex to close the mouth. If the patient intentionally or accidentally briefly opens his or her mouth wider when such a bite wedge is used, this tool will slip and must be realigned in relation to the dental arches. This tool is also perceived as unpleasant as the patient is usually forced to passively keep his or her mouth open very wide when blocking it from closing.

The use of an adjustable dental surgical light to illuminate the oral cavity is also known. A major disadvantage of such lights is that they frequently have to be readjusted to the work area. In connection with magnifying glasses, headlamps have become common, and optimally illuminate the visual field of the dentist without manipulation. Another attempt to bring light to the surgical site is made by connecting highly flexible, thin fiberoptic conductors to dental oral mirrors or suctioning tubes. However, these must be continuously manipulated by the dentist or assistants.

In addition, flexible metal hoses with ball ring elements are known for supplying drilling oil for machining; these are presented in a brochure by MZT Falkenreck, Bielefeld: “Snap-Loc, Flexible Kuehlwasserschlaeuche.” They consist of a plastic starting element having a connecting thread and do not last in long-term use. The term SNAPLOC® is a registered trademark of Böllhoff & Co. Montagefabrik GmbH & Co. KG, Bielefeld. SNAPLOC® may be understood to be a tubular push-fit mating ball element detachably connectable with a mating tubular ball-coupling element.

### OBJECTS AND SUMMARY OF THE INVENTION

An object of the invention is to create an improved suctioning device which optimally protects oral soft tissue from rotating dental instruments without using assistants, ensures optimum suctioning without assistance, avoids manual suctioning errors, in the form of painful pressure from resting on the periosteum, from tired personnel, and enables the reduction or elimination of the described problems.

The solution according to the invention includes attaching a swingable, rotatable, and bendable gooseneck hollow tube to a dental operative assembly with a holder A suctioning hose is guided through the hollow tube, and the suctioning unit is releasably connected to the suctioning hose on the holder side, and the oral suctioning tube is releasably connected to the free end of the oral suctioning tube.

The invention further includes additional advantageous embodiments within the scope of the invention asset forth below.

The use of the new suctioning tube holder relieves the assistant from holding the tool from one side in an orthopedically problematic manner. The assistant can restrict his or her to occasionally readjusting the aspirator and is freed of additional activities.

In an advantageous embodiment, the gooseneck hollow system, which fulfills the specific dental requirements of hygiene and functionality, is attachable as an assistant-free tool to a standard operative assembly with a minimum amount of effort. In another embodiment according to the invention, the flexible sheathing of the gooseneck suctioning tube continually dampens the suctioning noise at the site of origin. The noise level is therefore substantially lower than standard suctioning systems.

In particular, several different types of sheath layers may be used.

By combining the use of different types of overlapping hollow tubes, hoses, and wound silicone tape, flexibility is retained, the design is adjustable, and the sound is muffled. This effect directly reduces noise in the dental examination room, and no suctioning noise penetrates into adjacent rooms.

The gooseneck suctioning tube is advantageously affixed to a bite wedge provided with a fitting cutout. When a suitably configured suctioning tube is attached there, suctioning positions can be adjusted from a sagittal direction, which assistants cannot accomplish by purely manual means, or cannot hold for a long time for spatial reasons.

Fixing the bite wedge with a sagittal hole by shoving on the gooseneck suctioning tube enables the bite wedge to be secured against normal slipping in the mouth. This design allows a new suctioning position from a sagittal direction extending across the dental arches, which enables the bite wedge to be independently secured in position against sliding. In addition, this device allows the patient to control closing his or her mouth by shoving the device away if needed. Ensuring patient autonomy increases patient acceptance of blocking mouth closure with the bite wedge, which is desirable in treatment.

In another advantageous embodiment of the device, a fiberoptic conductor, either directly on the gooseneck suctioning tube or independent from it, is guided into another flexible, shape-retaining gooseneck, for a perioral or intraoral cold light outlet which is on, or in the oral cavity.

Associating the fiberoptic conductor system with the advantages of the invention, as set forth herein, allows for the aspirated and surgical areas to be precisely illuminated without an assistant in a self-holding manner.

Relative terms such as left, right, up, and down are for convenience only and are not intended to be limiting.

Advantageous embodiments according to the invention are shown in FIG. 1 to 7.

### BRIEF DESCRIPTION OF THE DRAWINGS

FIG. 1 shows a plan view of a holder for gooseneck tubes according to the invention;

FIG. 2 shows a side view of FIG. 1;

FIG. 3 shows a section of a suctioning hose connector;

FIG. 4 shows a section of an oral suctioning tube connector;

FIG. 5 shows a partial cutaway section of an inner gooseneck hollow tube;

FIG. 6 shows a cross-section of a gooseneck with a sheath;

FIG. 7 shows the entire device with a fiberoptic conductor.

### DETAILED DESCRIPTION OF THE INVENTION

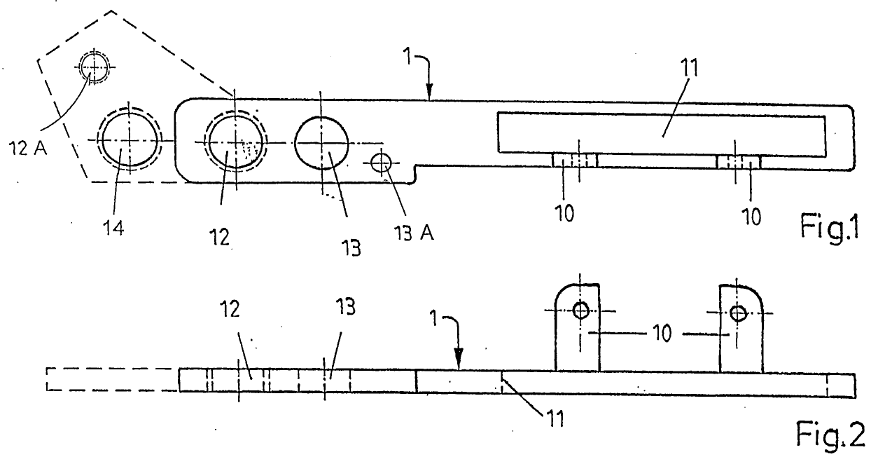

An embodiment of the holder according to the invention is shown in FIGS. 1 and 2 in which the gooseneck connects with a type A-Dec Cascade operative assembly.

To install the holder 1, the patient headrest is first pulled out. The backrest cushion is removed to gain access to the chair-side fastening element of the headrest. The top nuts are removed on the left and right, the holder 1 is then mounted with the cutout 11 and attached to the clips 10 with the available screws on the headrest element. The top spacing screws of the backrest must be screwed out as far as possible so that the nuts can grip the backrest with about 1-2 turns. The cushion slides past the holder 1 into its original position without being damaged. The headrest is shoved back on.

The threaded hole 12 in the holder 1, outside on the left in FIG. 1, serves to receive a hollow sleeve. For example, 38 commercially available SNAPLOC elements 44 as shown in FIG. 5 are pressed sequentially on to this hollow sleeve. The hollow sleeve 40 may be, in particular, made of metal.

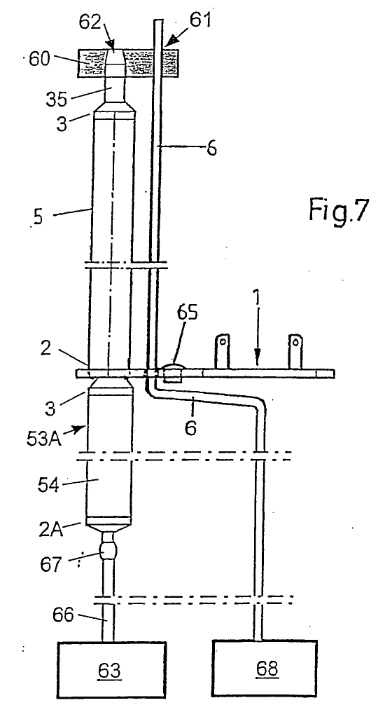

The length of goose neck articulated tube 4 in FIG. 7 may be sufficiently long at 90 cm for the described operative assembly, and through which, as shown in FIG. 6, a commercially available dental hose is guided. To withstand daily loads, SNAPLOC elements 44 are additionally stabilized by applying heat-shrink tubing 51. SNAPLOC elements 44, toward the holder 1, are additionally coated with several layers of shorter pieces of heat-shrink tubing 51 to counteract the various types of leverage in the gooseneck system 5 that could overload and quickly wear out the bottommost SNAPLOC elements. To ensure the flexibility and soundproofing of the gooseneck hollow system 5, a layer of silicone tape 52 is wound under each heat-shrink tubing layer 51.

To further increase soundproofing and provide an aesthetic and hygienically optimized overall configuration and, indeed, design, this flexible structure is also covered with a hose 53 of normal dental quality. Fitting connectors for the suctioning tube, and an A-Dec suctioning tube holder, join the hose ends of the hose and hollow element arrangement between the standard elements of the standard suctioning setup.

In FIG. 1, the two holes 13 in the holder 1 serve to temporarily receive a large or small dummy plug that is used to turn off the suctioning system at the conventional A-Dec assistant element. Another variation of the holder is portrayed in a dashed line, and a small suctioning hose passage 12A and a passage 14 for a separate fiberoptic conductor are provided therein.

Several borehole seats 12, 12A, and dummy plug borehole seats 13, 13A having different dimensions may be provided in the metal plate.

By adapting the dimensions to a known, small suctioning unit, the other embodiments allow one to also work with two parallel, self-fixing, gooseneck hollow systems with different cross-sections, and, in the same manner as the light source, may be maneuvered independent of each other.

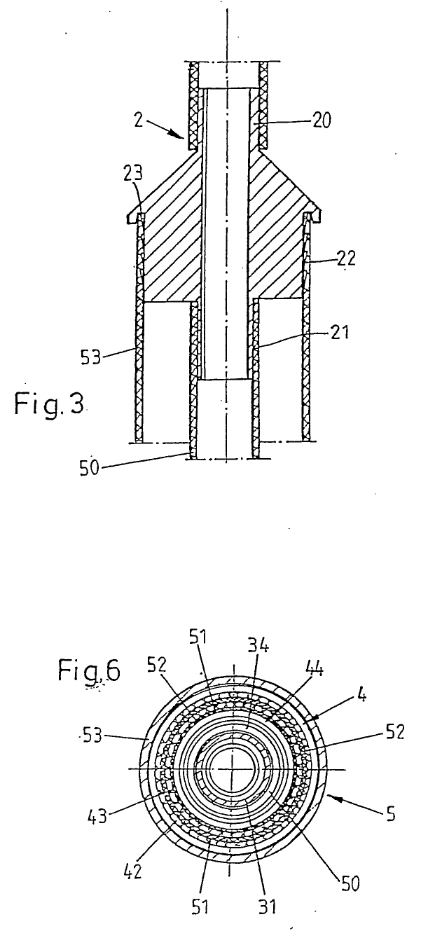

A section of a connector 2 that fits a normal suctioning hose or preferably an A-DEC suctioning hose holder is shown in FIG. 3. The connector 2 may consist of polyethylene (in white); however, it is preferably manufactured of a light metal to last longer. The other suctioning hose of the suctioning unit is shoved onto a single, slightly conical connection end 20 together with the suctioning tube holder, and the thinner inner hose 50 is shoved onto the bottom, stepped shoulder 21, and the wider outer hose 53 on the ribbed shoulder 22, that ends in an axial ring groove 23, whose groove width N is adapted to the thickness of the material of the outer hose 53.

The dimensions, in the example, are approximately 15 mm in diameter at the unit-side connection end 20, 14 mm in diameter for shoulder 21 of the inner hose 50, 40 mm in diameter at the shoulder 22 for the outer hose 53, and a 2 mm groove width N is matched to the width of the hose wall.

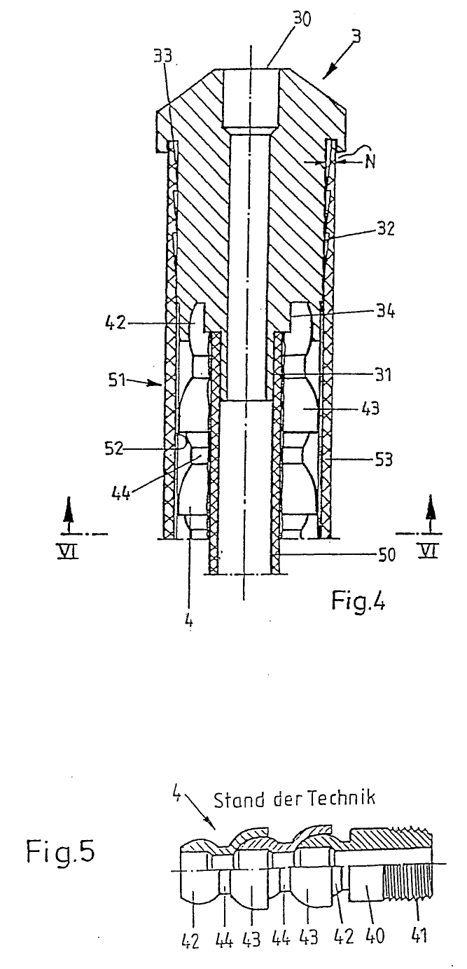

FIG. 4 shows a connector 3 for a conventional oral suctioning tube that is insertable in a sleeve-like recess 30. On the other hand, the oral tube connector 3 has a concentric outer hose shoulder 32 with a retention profile and an annular groove 33 for the outer hose 53, a tube seat shoulder 34 for the last SNAPLOC element, and an inner hose shoulder 31 for the inner hose 50. This connector also consists of plastic but is preferably made of light metal. Its diameter fits the connectable elements; for example: a 15 mm inner diameter for sleeve 30; a 40 mm outside diameter for the outer hose shoulder 32; a 23 mm outside diameter for the SNAPLOC element; and a14 mm outer diameter for the inner hose shoulder. The groove width N is 2 mm.

If an elastic bite wedge 60 is used, the oral tube connector 3 runs close to it, and a straight or bent intermediate tube 35 runs from the oral tube sleeve 30 into the bite wedge 60 from which the insertable oral tube exits on the other side of the passage 62.

A one-sided axial section of a known gooseneck hollow tube 4 is shown in FIG. 5. On the other end, an annular ball section 42 is shaped onto the sleeve-like start element 40 with a thread 41 on the end. This ball section is partially enclosed by a tightly-fitting, annular ball socket section 43 that is formed on a first tube element 44 of a chain of additional, tube-like elements that also have an internally fitting ball section 42 on the other end. The interlocking ball sections allow the element chain to flex and twist; however, the assumed shape resists minor external force from the friction in the tight ball seats even after frequent use. This makes them particularly suited for the objects set forth herein.

FIG. 6 shows the cross-section VI-VI of a gooseneck 5 of FIG. 4. From the inside to the outside, the following items surround each other:
An inner hose 50, such as a dental hose for major suctioning with a 19 mm diameter;
A gooseneck element 44, such as a SNAPLOC® gooseneck element;
Silicone tape 52;
Heat-shrink tubing 51, such as DSG-Canusa CPX55 heat-shrink tubing;
Another winding of silicone tape 52;
More heat-shrink tubing 51; and
An outer hose 53, such as Dürr-Dental hose with an inner diameter of 40 mm.

There can be a single layer or plurality of layers of silicone tape 52 and heat-shrink tubing 51. The heat-shrink tubing 51 is axially divided into short sections to provide sufficient mobility. This is another reason why the inner flexible silicone tape 52 only lies on the ball seats and not on the areas of movement of the ball elements.

The inner hose 50 has a gap in relation to the tube element 44, and the outer hose 53 is also somewhat wider than the widest heat-shrink hose so as not to restrict adjustability.

FIG. 7 shows a schematic drawing of the entire device. Proceeding from a suctioning unit 63, a suctioning hose 66 (that is shown shorter than it actually is and that ends in an original A-DEC suctioning tube holder 67) extends to the intermediate hose 54 that preferably extends to the holder 1, and includes a double, noise-suppressing hose system, similar to the gooseneck 5, reinforced with the SNAPLOC elements, and ends in the connectors 2, 3 like the gooseneck. The length of the flexible intermediate hose is, for example, 40 cm to allow easy handling when attaching and removing the suctioning tube holder 67. A dummy plug 65 may likewise be provided.

Proceeding from the holder 1, the gooseneck tube 5 screwed to the holder extends to the oral tube connector 3. A fiberoptic conductor 6 runs independently or parallel from a cold-light source 68 through the holder 1. Both are held on the bite wedge 60 in a passage 62 or channel 61, respectively. The oral tube is connected to the oral tube connector 3 or the bite wedge 60.

The suctioning hose 66 preferably also has a connector 2A. From that point, it is enclosed by a soundproofing sheath and an outer hose 53A.

The passages 61, 62 preferably open on the side with a narrow fit so that the fiberoptic conductor or suctioning hose can be easily inserted and removed. The bite wedge enables an appropriate suctioning tube to assume a sagittal suctioning position which cannot be (continuously) accessed for spatial reasons by the dentist or an assistant using purely manual means.

The new system meets specific dental requirements in regard to hygiene and functionality as an assistant-free additional tool on a standard operative assembly, which does not have to be altered. All connections steps can be easily done manually. Existing screws are used.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. Device for intraoral suctioning, comprising:
a) an oral suctioning tube releasably connected to a suctioning hose;
b) the suctioning hose being releasably connectable to a suctioning unit;
c) a swingable, rotatable, and bendable gooseneck hollow tube being attachable a dental operative assembly with a holder;
d) the suctioning hose being guided through the hollow tube;
e) the suctioning unit being releasably connected to the suctioning hose on a holder side thereof; and
f) the oral suctioning tube being releasably connected to a free and of the suctioning hose.

2. Device according to claim 1, wherein:
a) the gooseneck hollow tube is attached to a hollow sleeve start element at the holder side to which a tubular push-fit mating ball element is detachably connected with a mating tubular ball-coupling element.

3. Device according to claim 2, wherein:
a) the hollow sleeve start element is screwed to the holder with a threaded extension provided in a bore hole seat.

4. Device according to claim 2, wherein:
a) the tubular push-fit mating ball element and the mating tubular ball-coupling element include a ring ball head and a tightly fitting ring ball socket.

5. Device according to claim 2, wherein:
a) the tubular push-fit mating ball element and detachably connected mating tubular ball-coupling element is wound with at least a single layer of silicone tape surrounded by sections of a heat-shrink tubing.

6. Device according to claim 1, wherein:
a) an outside of the gooseneck hollow tube is surrounded by an outer hose.

7. Device according to claim 1, wherein:
a) the gooseneck hollow tube includes an air intake at an attachment side that bears a hose nipple at one end for a unit-side suctioning hose, and an inner hose extension and another outer hose extension on another side.

8. Device according to claim 1, wherein:
a) the gooseneck hollow tube bears a mouth tube connecting piece at the free end, and the mouth tube connector at the tube side has a stepped inner hose shoulder, an outer hose shoulder for a final tubular push-fit mating ball element and mating tubular ball-coupling element, and an outer hose shoulder, and it contains a mouth tube sleeve at the other end.

9. Device according to claim 8, wherein:
a) the outer hose shoulder end in an axial ring groove at a face side in an air intake, and in the mouth tube connector, and a width of the groove corresponds to a thickness of a material of the outer hose.

10. Device according to claim 1, wherein:
a) the holder is a metal plate with clips and a cutout that fit a commercially-available headrest holder of a dental operative assembly.

11. Device according to claim 10, wherein:
a) a dummy plug borehole seat, a fiberoptic conductor, and a borehole seat of the hollow sleeve starting element are provided in the metal plate of the holder.

12. Device according to claim 11, wherein:
a) the borehole seat includes several borehole seats and dummy plug borehole seats of different diameters in the metal plate of the holder.

13. Device according to claim 1, wherein:
a) an intermediate tube is provided, and the gooseneck with the intermediate tube are inserted in a passage of a bite wedge in which the mouth tube is insertable.

14. Device according to claim 13, wherein:
a) a fiberoptic conductor is fixed in a fiberoptic channel provided in the bite wedge.

15. Device according to claim 1, wherein:
a) a fiberoptic conductor is provided and runs parallel to the gooseneck hollow tube.

16. Device according to claim 6, wherein:
a) the outer hose includes a dental hose with an inner diameter of 40 mm.

17. Device according to claim 5, wherein:
a) the heat-shrink tubing includes heat-shrink sleeve sections of the type DSG Canusa CPX55.

18. Device according to claim 7, wherein:
a) the inner hose extension is a dental hose with an inner diameter of 19 mm.

19. Device according to claim 1, wherein:
a) the gooseneck hollow tube is 80-120 cm long.

20. Device according to claim 19, wherein:
a) the gooseneck hollow tube is 90 cm long and has 38 tubular push-fit mating ball elements and mating tubular ball-coupling elements.
